(19) United States
(12) Patent Application Publication
(10) Pub. No.: US 2025/0181429 A1
(43) Pub. Date: Jun. 5, 2025

(54) SYNCHRONIZING MIDDLEWARE PROCESS EXECUTION ON MULTIPLE PLATFORMS WITH CALLBACK CAPABILITIES

(71) Applicant: INTERNATIONAL BUSINESS MACHINES CORPORATION, ARMONK, NY (US)

(72) Inventors: PATRICK JOHN CLAS, PINE PLAINS, NY (US); VICTOR MANUEL MARTINS LOURENCO, VESTAL, NY (US); DAVID WALTERS, MANAHAWKIN, NJ (US)

(21) Appl. No.: 18/526,313

(22) Filed: Dec. 1, 2023

(51) Int. Cl. G06F 9/54

(52) U.S. Cl. CPC G06F 9/546; G06F 2209/547; G06F 2209/548

(57) ABSTRACT

Synchronizing middleware process execution on multiple platforms with callback capabilities includes receiving, by a first computing platform of a system, a first request for execution of a first transaction associated with execution of a process from a first client device, the first computing platform including a transaction service, receiving, by the first computing platform, a second request for execution of the first transaction, from a second client device, and queuing, by the transaction service, the first request and the second request for the transaction. The first computing platform determines, based on an execution status of the first transaction, whether to associate a result of the first transaction with the second request.

### BACKGROUND

The present disclosure relates to methods, apparatus, and products for synchronizing middleware process execution on multiple platforms with callback capabilities.

### SUMMARY

According to embodiments of the present disclosure, various methods, apparatus and products for synchronizing middleware process execution on multiple platforms with callback capabilities are described herein. In some aspects, synchronizing middleware process execution on multiple platforms with callback capabilities includes receiving, by a first computing platform of a system, a first request for execution of a first transaction associated with execution of a process from a first client device, the first computing platform including a transaction service, receiving, by the first computing platform, a second request for execution of the first transaction, from a second client device, and queuing, by the transaction service, the first request and the second request for the transaction. The first computing platform determines, based on an execution status of the first transaction, whether to associate a result of the first transaction with the second request.

### BRIEF DESCRIPTION OF THE DRAWINGS

FIG. 1 sets forth an example computing environment according to aspects of the present disclosure.

FIG. 2 sets forth another example computing environment according to aspects of the present disclosure.

FIGS. 3A-3C set forth a flow diagram of an example process flow according to aspects of the present disclosure.

FIG. 4 sets forth a flowchart of an example process for synchronizing middleware process execution on multiple platforms according to aspects of the present disclosure.

FIG. 5 sets forth a flowchart of another example process for synchronizing middleware process execution on multiple platforms according to aspects of the present disclosure.

FIG. 6 sets forth a flowchart of another example process for synchronizing middleware process execution on multiple platforms according to aspects of the present disclosure.

### DETAILED DESCRIPTION

A computing environment often utilizes multiple computing platforms to execute transactions. For example, a particular computing environment may include a primary computing platform and a secondary computing platform. In a particular example, the secondary computing platform functions as a backup for the primary computing platform. A transaction is a set of related tasks that are treated as a single action such as computing tasks to update a database, perform a configuration change of a computing system, or conduct an e-commerce purchase. It is often necessary to perform the same transaction on multiple platforms of a system. For example, a configuration change to a particular computing platform may need to be replicated on all computing platforms of a system in a synchronous manner. However, existing systems are primarily limited to synchronizing configuration management and alternation transactions to a single platform. If a system includes two or more platforms, the synchronization of these transactions are not viable. Moreover, a multiple platform system may only support two transaction types, synchronous transactions and asynchronous transactions, while callback capabilities are not supported. When a particular transaction requires information from the computing platform after execution of a transaction such as a confirmation of completion, a callback request is sent to the computing platform. The computing platform responds with a callback message including the requested information.

Various embodiments for synchronizing middleware process execution on multiple platforms with callback capabilities are disclosed. In an embodiment, a single transaction service responsible for all transaction execution and synchronization is run on a primary platform of a multiple platform system. Callback services that communicate with the transaction service are run on all platforms within the system. In the embodiment, at least three transaction types are supported within the multiple platform system: synchronous, asynchronous, and callbacks. In a synchronous transaction type, the processor that issued the transaction waits until the transaction is complete. In an asynchronous transaction type, the processor that issued the transaction is freed up to run other tasks rather than wait until the transaction is complete. In a callback transaction type, a callback message is provided to the processor after execution of the transaction providing information about the transaction such as an indication of completion of the transaction or results of the completion of the transaction.

Upon receiving a request for a transaction (e.g., rebuilding product data), a dynamic queuing mechanism is used by the transaction service to synchronize the execution of the requested transaction across all platforms of the multiple platform system and gather any data resulting from the transaction. Callback requests for a given transaction are stored for utilization completion of the transaction. When ready, the transaction service routes the callback requests to all necessary callback services residing on various platforms of the multiple platform system. The callback services are responsible for invoking a functional callback to any client that initially made a callback request to the transaction service. Accordingly, external and internal users are provided with the capability to act on transactions results in real time in an event drive capacity. In particular embodiments, the transaction service and callback services reside in middleware of their respective computing platforms. Middleware is software that enables communication between an operating system and an end user or end-user applications by providing functions not provided for by the operating system.

In an embodiment, a first computing platform (e.g., a primary platform) of a system including a transaction service receives a first request for execution of a first transaction associated with execution of a process from a first client device and receives a second request for execution of the first transaction, from a second client device. The transaction service queues the first request and the second request for the transaction. The transaction service determines, based on the execution status of the first transaction, whether to associate a result of the first transaction with the second request. In a particular embodiment, associating the result of the first transaction with the second request is based on the execution status of the first transaction being that the first transaction is currently executing on the first computing platform is or queued for execution on the first computing platform. In a particular embodiment, the transaction services sends the result of the first transaction to the first client device and the second client device.

In another particular embodiment, the second request is executed using a second transaction based on determining not to associate the result of the first transaction with the second request, for example, if the first transaction is not currently executing or queued for execution. In an embodiment, the transaction service routes a callback request associated with the first transaction to the first computing platform. In a particular embodiment, the callback request is received from one or more of the first host device and the second host device. In an embodiment, a callback service of the first computing platform sends a callback notification to a one or more of the first client device or the second client device responsive to receiving the callback request. In a particular embodiment, the callback service resides in middleware of the first computing platform.

In another embodiment, the transaction service determines that the first transaction is queued by the transaction service, and attaches the second request to the pending transaction. In a particular embodiment, the transaction service resides in middleware of the first computing platform. In a particular embodiment, the first transaction comprises a configuration management transaction for the first computing platform. In another embodiment, the configuration management transaction includes a configuration change for the first computing platform.

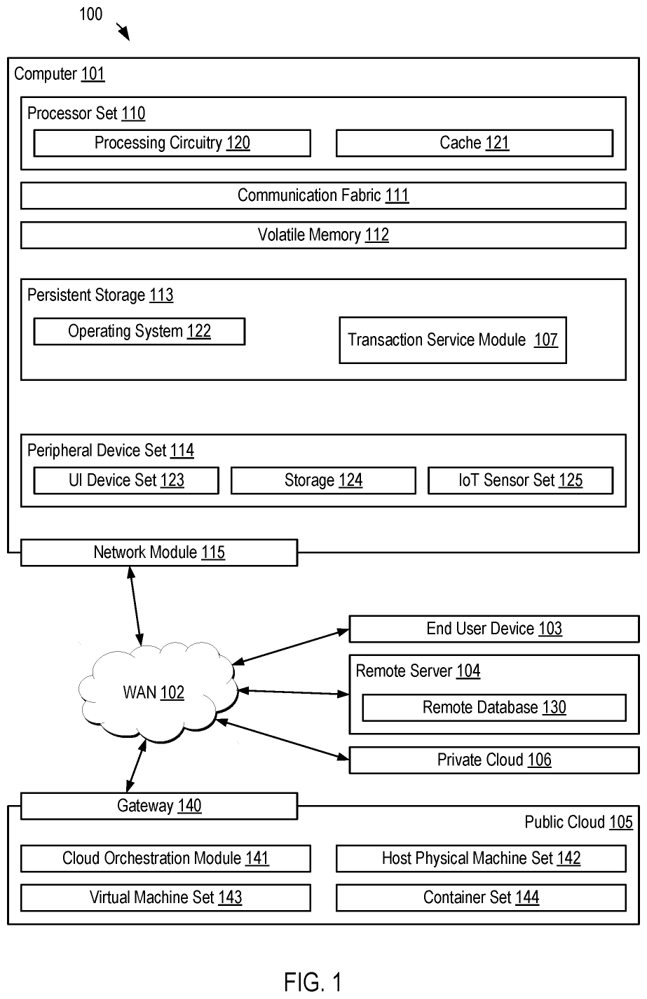

FIG. 1 sets forth an example computing environment according to aspects of the present disclosure. Computing environment 100 contains an example of an environment for the execution of at least some of the computer code involved in performing the various methods described herein, such as transaction service module 107. In addition to transaction service module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and transaction service module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in transaction service module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in transaction service module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

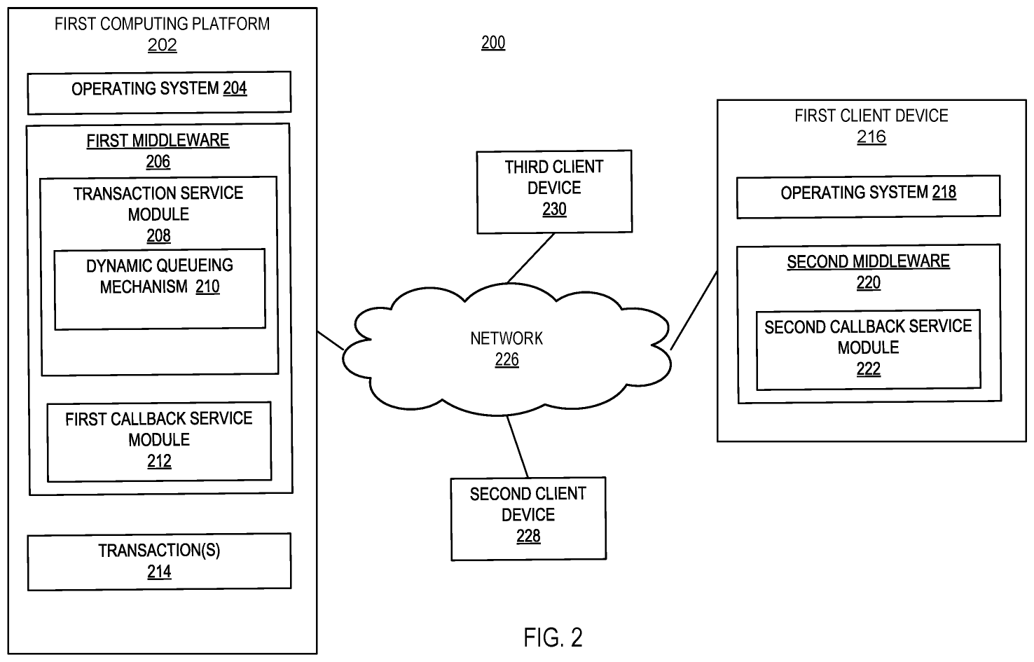

Referring now to FIG. 2, FIG. 2 sets forth another example computing environment according to aspects of the present disclosure. Computing environment 200 includes a first computing platform 202. In a particular embodiment, the first computing platform 202 is a primary computing platform. In a particular embodiment, the first computing platform 202 includes the computer 101 described with respect to FIG. 1. The first computing platform 202 includes an operating system 204 and first middleware 206. The first middleware 206 includes a transaction service module 208 including a dynamic queueing mechanism 210. The transaction service module 208 includes a transaction service configured to perform the various transaction service functions described herein. The first middleware 206 further includes a first callback service module 212 including a callback service configured to perform the callback functions described herein. The first computing platform 202 further includes one or more transactions 214 for execution by the first computing platform 202. In a particular embodiment, the transaction service module 208 includes the transaction service module 107 of FIG. 1.

The computing environment 200 further includes a first client device 216. In a particular embodiment, the first client device 216 is a secondary or backup computing platform. The first client device 216 includes an operating system 218 and second middleware 220. The second middleware 220 includes a second callback service module 222. The first computing platform 202 is in communication with the first client device 216 via a network 226. In a particular embodiment, the first computing platform 202 and the first client device 216 are located in different locations. The first client device 216 is configured to allow a user to request execution of one or more of the transaction 214 by the first computing platform 202 and the second callback service module 222 is configured to issue a callback request associated with a transaction to the first computing platform 202. In an embodiment, the computing environment 200 further includes a second client device 228 and a third client device 230 in communication with the network 226. The second client device 228 and the third client device 230 are each configured to allow a user to request execution of one or more of the transactions 214 by the first computing platform 202. In a particular example, a user associated with the first client device 216 requests a transaction that includes configuration change for the first computing platform 202. In another particular example, the second client device 228 requests execution of a synchronous transaction and the third client device 230 requests execution of an asynchronous transaction by the first computing platform 202. Although the implementation illustrated in FIG. 2 is shown as utilizing a single computing platform, in other embodiments the computing environment 200 includes multiple computing platforms.

In example operation, a user associated with first client device 216 sends a first request for a first transaction including a configuration change to the first computing platform 202. The transaction service module 208 receives the first request for the first transaction, and queues the first request for the transaction using the dynamic queuing mechanism 210. The second client device 228 sends a second request for a second transaction to the first computing platform 202. The transaction service module 208 determines whether to associate a result of the first transaction with the second request based on the execution status of the first transaction and whether the request for the first transaction and the request for the second transaction are both a request for the same transaction. In a particular embodiment, the transaction service module 208 determines whether a version of the second request is already in-progress or pending (e.g., the first transaction associated with the first request), and attaches the second request to the in-progress or pending transaction if a version of the request is determined to be already in-progress or pending. If a version of the request is not already in-progress or pending, the request is sent as a new request to execute the second request using a new transaction.

In an example operation, the transaction service module 208 receives a callback request from the first client device 216 requesting a callback notification message after completion of the transaction. The transaction service module 208 routes the callback request associated with the transaction to the first callback service module 212 of the first computing platform 202. Responsive to receiving the callback request, the first callback service module 212 sends a callback notification to the first client device 216.

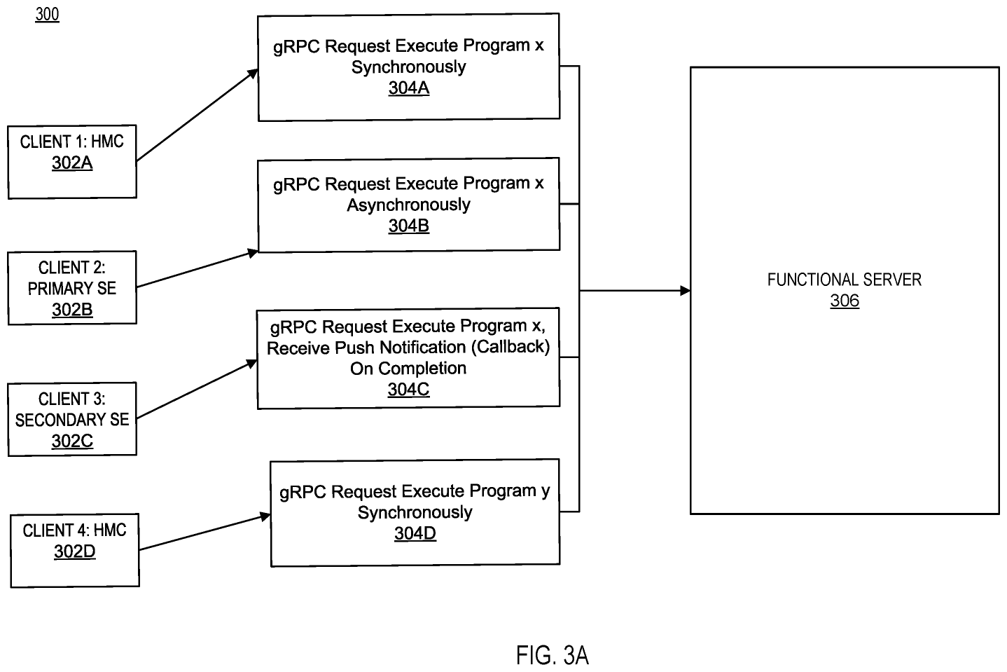

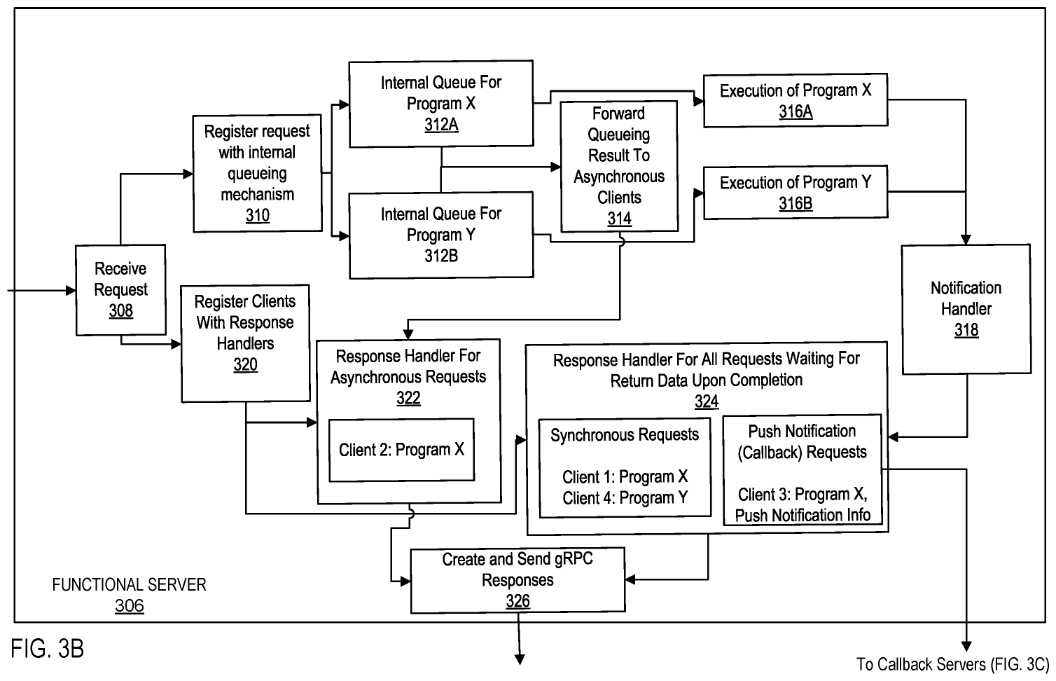

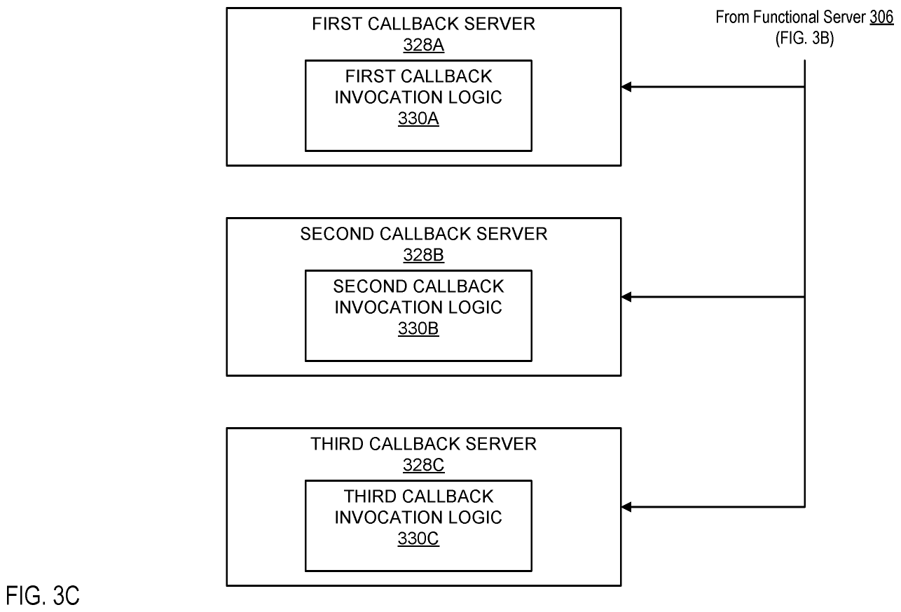

Referring now to FIGS. 3A-3C, FIGS. 3A-3C set forth a flow diagram of an example process flow according to aspects of the present disclosure. In the process flow 300, first client 302A, a second client 302B, a third client 302C, and a fourth client 302D each send a request to execute a program to a functional server 306. In the example of FIGS. 3A-3C, the first client 302A and the fourth client 302D are each clients of a hardware management console (HMC). In other examples, the first client 302A and the fourth client 302D are each clients of separate HMCs. A HMC is a hardware device that allows a user to configure and control aspects of a managed system such as changing configuration information and managing logical partitions. In the example, the second client 302B is a primary support element (SE) and the third client 302C is a secondary (or backup) SE. An SE contains one or more processors to execute transactions. In a particular embodiment, the second client 302B is comprised of the first computing platform 202 of FIG. 2 and the third client 302C is comprised of a second computing platform. In the example flow, the functional server 306 is hosted on the second client 302B. However, in other embodiments, the functional server 306 can be hosted on any computing platform within a multiple platform system.

In the example flow, the first client 302A sends a Remote Procedure Call (RPC) request (304A) to execute a Program X synchronously to the functional server 306, the second client 302B sends an RPC request (304B) to execute Program X asynchronously to the functional server 306, the third client 302C sends an RPC request (304C) to execute Program X and receive a push notification (callback) on completion to the functional server 306, and the fourth client 302D sends an RPC request (304D) to execute a Program Y synchronously to the functional server 306. In a particular embodiment, the RPC requests are open source RPC (gRPC) requests.

For each of the requests, the functional server 306 receives (308) the request, and registers (310) the request with an internal queuing mechanism. In a particular embodiment, the internal queuing mechanism comprises the dynamic queuing mechanism 210 of FIG. 2. The functional server 306 registers (320) the clients with either a response handler for asynchronous requests 322 or a response handler for all requests waiting for return data upon completion 324.

An internal queue for Program X (312A) is configured to determine if a version of the request for Program X is already running or not. If a version of the request is not running, the request for Program X is added to the queue. Alternately, if a version of the request for Program X is running, the request for Program X is attached to the existing transaction or, if a queued transaction request of Program X exists, the request may attach to the queued transaction. If the request for Program X is an asynchronous request (e.g., the request from the second client 302B), the functional server 306 forwards (314) the queuing result to the response handler for asynchronous requests 322 (e.g., the request for Program X from the second client 302B). The internal queue for Program X 312A forwards the request and Program X is executed 316A, and the internal queue for Program Y 312B forwards the request and Program Y is executed 316B.

A notification handler 318 encapsulates the results of the execution of Program X and Program Y, and forwards the encapsulated results to the response handler for all requests waiting for return data upon completion 324. The requests waiting for return data upon completion include synchronous requests (the first client 302A: Program X, and the fourth client 302D: Program Y) and push notification (callback) requests (e.g., the third client 302C: Program X, push notification information). The functional server 306 creates and sends (326) gRPC responses to each of the first client 302A, the second client 302B, the third client 302C, and the fourth client 302D based upon the results received from the response handler for asynchronous requests 322 and the response handler for all requests waiting for return data upon completion 324.

In addition, the push notifications (e.g., callback requests) are sent to one or more of a first callback server 328A, a second callback server 328B, and a third callback server 328C. The first callback server 328A includes first callback invocation logic 330A, the second callback server 328B includes second callback invocation logic 330B, and the third callback server 328C includes third callback invocation logic 330C. In one or more embodiments, each of the first callback invocation logic 330A, the second callback invocation logic 330B, and the third callback invocation logic 330C include a callback service configured to send a callback notification message to a particular client (e.g., the third client 302C) in response to receiving a callback request.

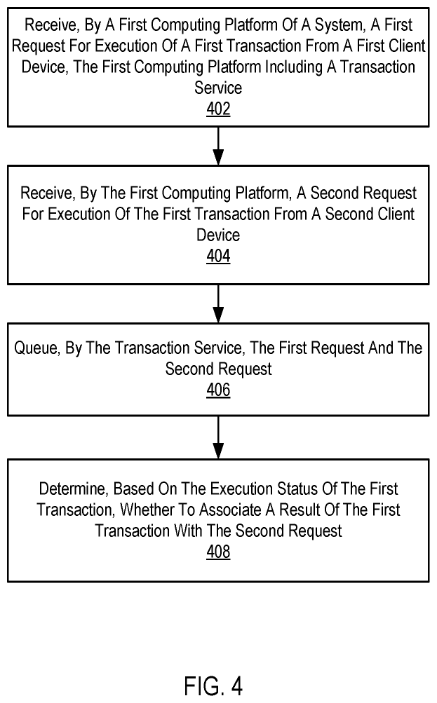

Referring now to FIG. 4, FIG. 4 sets forth a flowchart of an example process for synchronizing middleware process execution on multiple platforms according to aspects of the present disclosure. The first computing platform 202 of a system receives 402 a first request for execution of a first transaction from the first client device 216. The first computing platform 202 includes a transaction service module 208. In a particular embodiment, the transaction service module 208 resides in middleware of the first computing platform 202. The first computing platform 202 receives 404 a second request for execution of the first transaction from the second client device 228.

The transaction service module 208 queues 406 the first request and the second request, and determines 408, based on the execution status of the first transaction, whether to associate a result of the first transaction with the second request. In a particular embodiment, the transaction comprises a configuration management transaction for the first computing platform. In another particular embodiment, the configuration management transaction includes a configuration change for the first computing platform.

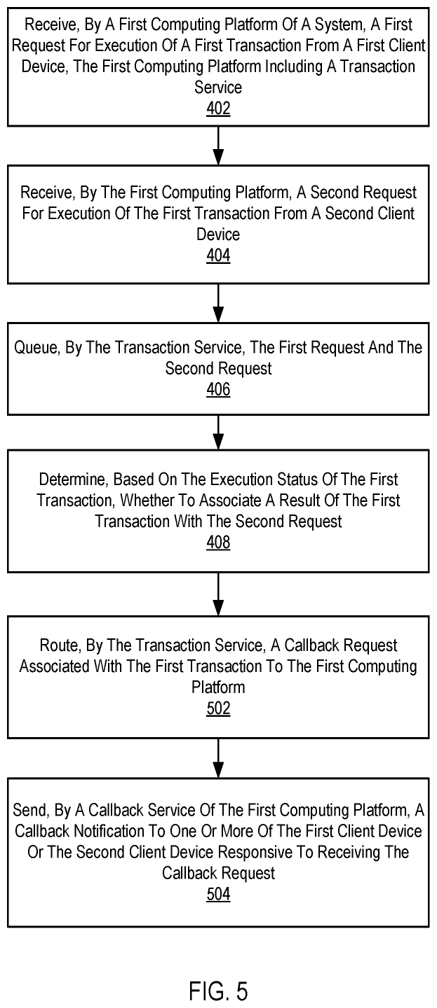

Referring now to FIG. 5, FIG. 5 sets forth a flowchart of another example process for synchronizing middleware process execution on multiple platforms according to aspects of the present disclosure. The example process of FIG. 5 includes the steps described with respect to the example process of FIG. 4 and further includes routing 502, by the transaction service module 208, a callback request associated with the first transaction to the first computing platform 202. A callback service of the first computing platform 202 sends 504 a callback notification to the first client device 216 or the second client device 228 responsive to receiving the callback request. In a particular embodiment, the callback service includes callback service provided by the first callback service module 212 of the first computing platform 202 of FIG. 2. In another particular embodiment, the callback service resides in the first middleware 206 of the first computing platform 202.

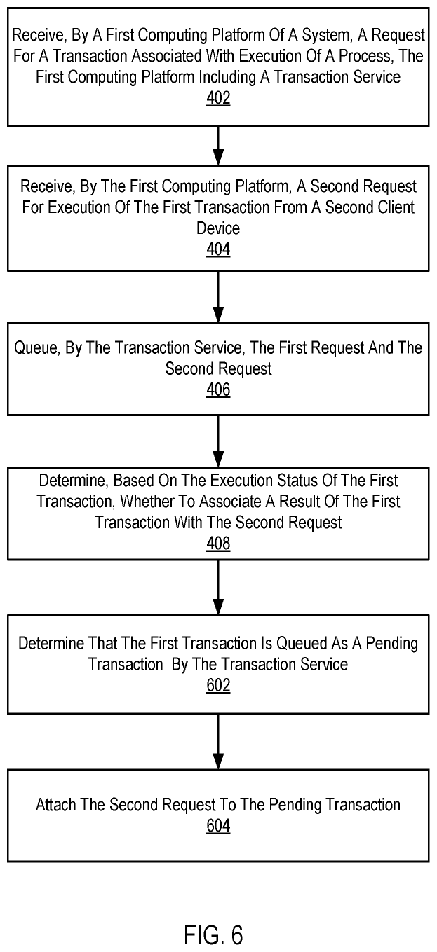

Referring now to FIG. 6, FIG. 6 sets forth a flowchart of another example process for synchronizing middleware process execution on multiple platforms according to aspects of the present disclosure. The example process of FIG. 6 includes the steps described with respect to the example process of FIG. 4 and further includes determining 602 determining that a pending transaction is queued by the transaction service. In a particular embodiment, the pending transaction is related to the requested transaction. In another particular embodiment, the pending transaction and the requested transaction are a request for execution of the same task or transaction. The process of FIG. 6 further includes attaching 604 the second request to the pending transaction.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a first computing platform of a system, a first request for execution of a first transaction from a first client device, the first computing platform including a transaction service;
receiving, by the first computing platform, a second request for execution of the first transaction, from a second client device;
queuing, by the transaction service, the first request and the second request; and
determining, based on an execution status of the first transaction, whether to associate a result of the first transaction with the second request.

2. The method of claim 1, further comprising associating the result of the first transaction with the second request based on the execution status of the first transaction being that the first transaction is currently executing.

3. The method of claim 2, further comprising sending the result of the first transaction to the first client device and the second client device.

4. The method of claim 1, further comprising:
executing the second request using a second transaction based on determining not to associate the result of the first transaction with the second request.

5. The method of claim 1, further comprising routing, by the transaction service, a callback request associated with the first transaction to the first computing platform.

6. The method of claim 5, further comprising sending, by a callback service of the first computing platform, a callback notification to one or more of the first client device or the second client device responsive to receiving the callback request.

7. The method of claim 6, wherein the callback service resides in middleware of the first computing platform.

8. The method of claim 1, further comprising:
determining that the first transaction is queued as a pending transaction by the transaction service; and
attaching the second request to the pending transaction.

9. The method of claim 1, wherein the transaction service resides in middleware of the first computing platform.

10. The method of claim 1, wherein the first transaction comprises a configuration management transaction for the first computing platform.

11. The method of claim 10, wherein the configuration management transaction includes a configuration change for the first computing platform.

12. An apparatus comprising:
a processing device; and
memory operatively coupled to the processing device, wherein the memory stores computer program instructions that, when executed, cause the processing device to:
receive, by a first computing platform of a system, a first request for execution of a first transaction from a first client device, the first computing platform including a transaction service;
receive, by the first computing platform, a second request for execution of the first transaction, from a second client device;
queue, by the transaction service, the first request and the second request; and
determine, based on an execution status of the first transaction, whether to associate a result of the first transaction with the second request.

13. The apparatus of claim 12, wherein the computer program instructions, when executed, further cause the processing device to route, by the transaction service, a callback request associated with the first transaction to the first computing platform.

14. The apparatus of claim 13, wherein the computer program instructions, when executed, further cause the processing device to send, by a callback service of the first computing platform, a callback notification to one or more of the first client device or the second client device responsive to receiving the callback request.

15. The apparatus of claim 14, wherein the callback service resides in middleware of the first computing platform.

16. The apparatus of claim 12, wherein the computer program instructions, when executed, further cause the processing device to:
determine that the first transaction is queued as a pending transaction by the transaction service; and
attach the second request to the pending transaction.

17. A computer program product comprising a computer readable storage medium, wherein the computer readable storage medium comprises computer program instructions that, when executed:
receive, by a first computing platform of a system, a first request for execution of a first transaction from a first client device, the first computing platform including a transaction service;
receive, by the first computing platform, a second request for execution of the first transaction, from a second client device;
queue, by the transaction service, the first request and the second request; and
determine, based on an execution status of the first transaction, whether to associate a result of the first transaction with the second request.

18. The computer program product of claim 17, wherein the computer program instructions, when executed, route, by the transaction service, a callback request associated with the first transaction to the first computing platform.

19. The computer program product of claim 18, wherein the computer program instructions, when executed, send, by a callback service of the first computing platform, a callback notification to one or more of the first client device or the second client device responsive to receiving the callback request.

20. The computer program product of claim 17, wherein the computer program instructions, when executed:
determine that the first transaction is queued as a pending transaction by the transaction service; and
attach the second request to the pending transaction.
